(19) United States
(12) Patent Application Publication
(10) Pub. No.: US 2023/0158606 A1
(43) Pub. Date: May 25, 2023

(54) LASER WELDING METHOD AND LASER WELDING DEVICE

(71) Applicant: Panasonic Intellectual Property Management Co., Ltd., Osaka (JP)

(72) Inventors: JINGBO WANG, Hyogo (JP); TSUTOMU SUGIYAMA, Osaka (JP); SHUNSUKE KAWAI, Osaka (JP); KENZO SHIBATA, Hyogo (JP); MASASHI ISHIGURO, Hyogo (JP); ATSUHIRO KAWAMOTO, Hyogo (JP)

(21) Appl. No.: 18/158,457

(22) Filed: Jan. 23, 2023

Related U.S. Application Data
(63) Continuation of application No. PCT/JP2021/036379, filed on Oct. 1, 2021.

(30) Foreign Application Priority Data
Oct. 5, 2020 (JP) 2020-168501

(51) Int. Cl. B23K 26/21; B23K 26/082; B23K 26/08

(52) U.S. Cl. CPC B23K 26/21; B23K 26/082; B23K 26/0884

(57) ABSTRACT

Provided is a laser welding method including a welding step of welding a workpiece by irradiating a surface of a workpiece with a laser beam that is swept two-dimensionally while being advanced in an X direction. In the welding step, the laser beam is swept to draw a predetermined pattern on the surface of the workpiece. Additionally, drawing speed and output of the laser beam are controlled to have an equal amount of heat input per unit drawing length in the predetermined pattern over the entire length of the predetermined pattern. The predetermined pattern is a continuous pattern in which two annular patterns are in contact with each other at one point.

This application is a continuation application of the PCT International Application No. PCT/JP2021/036379 filed on Oct. 1, 2021, which claim the benefit of foreign priority of Japanese patent application No. 2020-168501 filed on Oct. 5, 2020, the contents all of which are incorporated herein by reference.

### TECHNICAL FIELD

The present disclosure relates to a laser welding method and a laser welding device.

### BACKGROUND ART

Laser welding enables performing welding at high speed and with high quality because a workpiece of an object to be welded is irradiated with a laser beam having high power density. In particular, scanning welding for performing welding while a surface of a workpiece is scanned with a laser beam at high speed enables the laser beam to be moved to a next welding point at high speed during a period in which welding is not performed, and thus enabling total welding time to be shortened (e.g., see PTL 1). Conventionally proposed scanning methods with a laser beam include a method of scanning with a laser beam while drawing a Lissajous pattern on a surface of a workpiece (e.g., see PTL 2 and PTL 3).

### CITATION LIST

### Patent Literature

PTL 1: Unexamined Japanese Patent Publication No. 2005-095934
PTL 2: Unexamined Japanese Patent Publication No. S60-177983
PTL 3: Unexamined Japanese Patent Publication No. H11-104877

### SUMMARY OF THE INVENTION

### Technical Problem

Unfortunately, when the Lissajous pattern is drawn on the surface of the workpiece, a conventional method as disclosed in PTLs 2, 3 may cause drawing speed in each part of the pattern, or welding speed to be inconstant. In particular, a large speed difference may occur between a part where the pattern is linearly drawn and a part where the pattern is changed in direction.

As described above, when a large speed difference occurs during drawing of the Lissajous pattern, the amount of heat input to the workpiece, specifically, the amount of heat input per unit drawing length varies depending on the pattern, or a region of a molten pool. That is, the amount of heat input to the workpiece becomes non-uniform in the Lissajous pattern (molten pool), so that a weld bead may not be formed in a favorable shape during welding. Such a problem also occurs when the scanning pattern of the laser beam is not a Lissajous pattern, but a continuous pattern in which two circular patterns are in contact with each other at one point, for example.

The present disclosure is made in view of such a point, and it is an object of the present disclosure to provide a laser welding method and a laser welding device capable of obtaining a weld bead in a favorable shape by making the amount of heat input in a scanning pattern of a laser beam uniform.

### Solution to Problem

To achieve the above object, a laser welding method according to the present disclosure includes a welding step of welding a workpiece by irradiating a surface of the workpiece with a laser beam by two-dimensionally sweeping the laser beam while causing the laser beam to travel in a first direction. In the welding step, the laser beam is swept to draw a predetermined pattern on the surface of the workpiece, and drawing speed and output of the laser beam are controlled to have an equal amount of heat input per unit drawing length in the predetermined pattern over an entire length of the predetermined pattern. The predetermined pattern is a continuous pattern in which two annular patterns are in contact with each other at one point.

A laser welding device according to the present disclosure at least includes a laser oscillator that generates a laser beam, a laser head that receives the laser beam and irradiates a workpiece with the laser beam, and a controller that controls operation of the laser head. The laser head includes a laser scanner that sweeps the laser beam in each of a first direction and a second direction intersecting the first direction. The controller drives and controls the laser scanner to cause the laser beam to draw a predetermined pattern on a surface of the workpiece. The controller controls drawing speed and output of the laser beam to have an equal amount of heat input per unit drawing length in the predetermined pattern over an entire length of the predetermined pattern. The predetermined pattern is a continuous pattern in which two annular patterns are in contact with each other at one point.

### Advantageous Effect of Invention

The present disclosure enables a weld bead in a favorable shape to be obtained by making the amount of heat input in a scanning pattern of a laser beam uniform.

### BRIEF DESCRIPTION OF THE DRAWINGS

FIG. 1 is a schematic configuration view of a laser welding device according to a first exemplary embodiment.

FIG. 2 is a schematic configuration view of a laser scanner.

FIG. 3 is a schematic diagram illustrating a drawing distance in a Lissajous pattern.

FIG. 4 is a diagram illustrating a scanning pattern of a laser beam according to the present exemplary embodiment.

FIG. 5 is a diagram illustrating a relationship between drawing speed and output of a laser beam at a drawing position of the laser beam.

FIG. 6A is a diagram illustrating a first scanning pattern of a laser beam according to a first modification.

FIG. 6B is a diagram illustrating a second scanning pattern of a laser beam according to the first modification.

FIG. 7A is a diagram illustrating a third scanning pattern of a laser beam according to the first modification.

FIG. 7B is a diagram illustrating a fourth scanning pattern of a laser beam according to the first modification.

FIG. 7C is a diagram illustrating a fifth scanning pattern of a laser beam according to the first modification.

FIG. 8 is a diagram illustrating an example of a combination of parameters when a Lissajous pattern is drawn.

FIG. 9 is a diagram illustrating a relationship between a drawing position of a laser beam and drawing speed of the laser beam according to a second exemplary embodiment.

FIG. 10A is a diagram illustrating a first scanning pattern of a laser beam according to a second modification.

FIG. 10B is a diagram illustrating a second scanning pattern of a laser beam according to the second modification.

FIG. 10C is a diagram illustrating a third scanning pattern of a laser beam according to the second modification.

### DESCRIPTION OF EMBODIMENT

Hereinafter, exemplary embodiments of the present disclosure will be described with reference to the drawings. The following description of preferable exemplary embodiments is merely illustrative in nature, and is not intended to limit the present disclosure, its application, or its use.

### First Exemplary Embodiment

### [Configurations of Laser Welding Device and Laser Scanner]

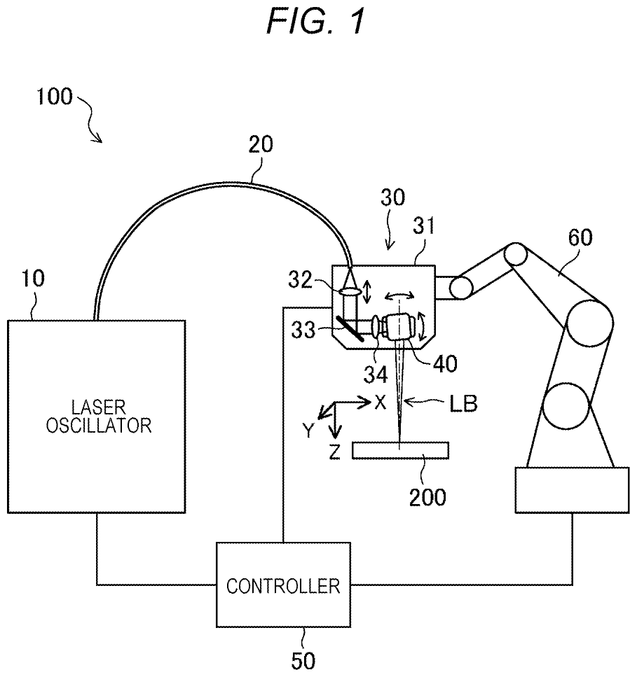

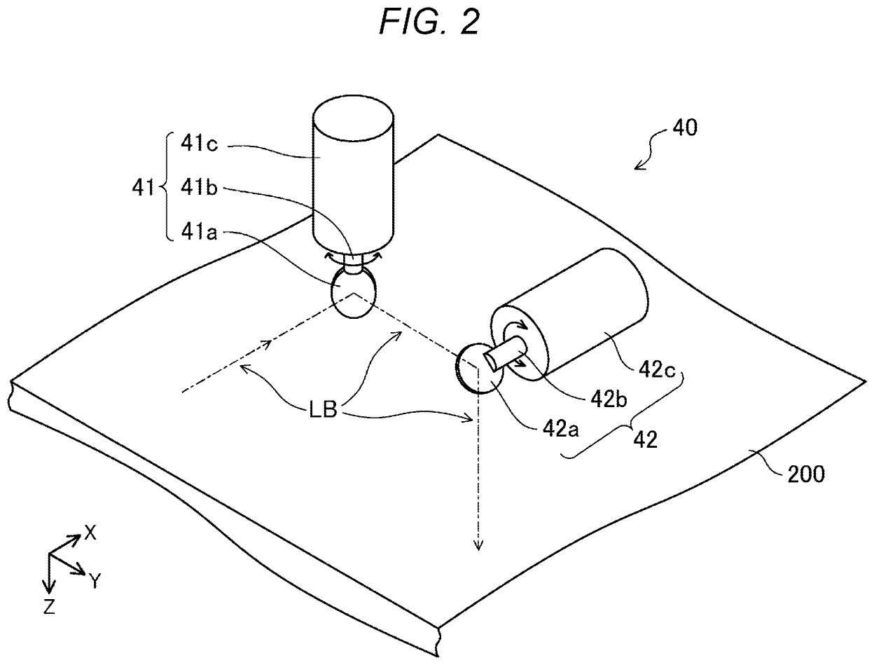

FIG. 1 illustrates a schematic view of a configuration of a laser welding device according to the present exemplary embodiment, and FIG. 2 illustrates a schematic configuration view of a laser scanner.

In the following description, a direction parallel to a traveling direction of laser beam LB from reflection mirror 33 toward laser scanner 40 may be referred to as an X-direction, a direction parallel to an optical axis of laser beam LB emitted from laser head 30 may be referred to as a Z-direction, and a direction orthogonal to each of the X-direction and the Z-direction may be referred to as a Y-direction. When a surface of workpiece 200 is formed as a flat surface, an XY plane including the X-direction and the Y-direction therein may be substantially parallel to the surface of workpiece 200, or may form a certain angle with respect to the surface of workpiece 200.

As illustrated in FIG. 1, laser welding device 100 includes laser oscillator 10, optical fiber 20, laser head 30, controller 50, and manipulator 60.

Laser oscillator 10 is a laser beam source that is supplied with power from a power supply (not illustrated), and that generates laser beam LB. Laser oscillator 10 may include a single a laser beam source, or may include multiple laser modules. In the latter case, laser beams emitted from respective multiple laser modules are combined into and then emitted as laser beam LB. The laser beam source or the laser modules used in laser oscillator 10 are appropriately selected in accordance with a material, a form of a weld, or the like of workpiece 200.

For example, a fiber laser or a disk laser, or an yttrium aluminum garnet (YAG) laser can be used as the laser beam source. In this case, laser beam LB has a wavelength set in a range from 1000 nm to 1100 nm, inclusive. A semiconductor laser may also be used as the laser beam source or the laser module. In this case, laser beam LB has a wavelength set to a range from 800 nm to 1000 nm, inclusive. A visible-light laser may be also used as the laser beam source or the laser module. In this case, laser beam LB ha a wavelength set in a range from 400 nm to 600 nm, inclusive.

Optical fiber 20 is optically coupled to laser oscillator 10, and laser beam LB generated in laser oscillator 10 is incident to optical fiber 20 and then transmitted through the inside of optical fiber 20 toward laser head 30.

Laser head 30 is attached to an end part of optical fiber 20 to emit laser beam LB toward workpiece 200, laser beam LB being transmitted through optical fiber 20.

Laser head 30 includes collimation lens 32, reflection mirror 33, condenser lens 34, and laser scanner 40, which serve as optical components, and housing 31 houses inside these optical components while maintaining a predetermined placement relationship among them.

Collimation lens 32 receives laser beam LB emitted from optical fiber 20. Collimation lens 32 converts laser beam LB into collimated light, and causes the collimated light to be incident on reflection mirror 33. Collimation lens 32 is connected to a driver (not illustrated), and is configured to be able to displace in the Z-direction in response to a control signal from controller 50. Displacing collimation lens 32 in the Z-direction causes laser beam LB to be changed in focal position, and thus enabling laser beam LB to be appropriately emitted in accordance with the form of workpiece 200. That is, collimation lens 32 in combination with the driver (not illustrated) also functions as a focal position adjustment mechanism for laser beam LB. The driver may displace condenser lens 34 to change the focal position of laser beam LB.

Reflection mirror 33 reflects laser beam LB transmitted through collimation lens 32 to cause laser beam LB to be incident to laser scanner 40. Reflection mirror 33 is provided with a surface forming an angle of about 45 degrees with respect to the optical axis of laser beam LB transmitted through collimation lens 32.

Condenser lens 34 condenses laser beam LB on the surface of workpiece 200, laser beam LB being reflected by reflection mirror 33 and swept by laser scanner 40.

As illustrated in FIG. 2, laser scanner 40 is a known galvano-scanner, which includes first galvano-mirror 41 and second galvano-mirror 42. First galvano-mirror 41 includes first mirror 41a, first rotation shaft 41b, and first driver 41c. Second galvano-mirror 42 includes second mirror 42a, second rotation shaft 42b, and second driver 42c. Laser beam LB transmitted through condenser lens 34 is reflected at first mirror 41a, and is further reflected at second mirror 42a. Then, the surface of workpiece 200 is irradiated with laser beam LB.

For example, first driver 41c and second driver 42c are each a galvano motor, and first rotation shaft 41b and second rotation shaft 42b are each an output shafts of the motor. Although not illustrated, when first driver 41c is rotationally driven by a driver that operates in response to a control signal from controller 50, first mirror 41a attached to first rotation shaft 41b is rotated about the axis of first rotation shaft 41b. Similarly, when second driver 42c is rotationally driven by a driver that operates in response to a control signal from controller 50, second mirror 42a attached to second rotation shaft 42b is rotated about the axis of second rotation shaft 42b.

When first mirror 41a is rotationally moved about the axis of first rotation shaft 41b to a predetermined angle, laser beam LB is swept in the X-direction. When second mirror 42a is rotationally moved about the axis of second rotation shaft 42b to a predetermined angle, laser beam LB is swept in the Y-direction. That is, laser scanner 40 is configured to sweep laser beam LB two-dimensionally within the XY plane to emit laser beam LB toward workpiece 200.

Controller 50 controls laser oscillation of laser oscillator 10. Specifically, controller 50 performs the laser oscillation control by providing control signals for an output current, on/off time, and the like to a power supply (not illustrated) connected to laser oscillator 10.

Controller 50 also controls operation of laser head 30 in accordance with content of a selected laser welding program. Specifically, controller 50 performs drive control on laser scanner 40 and the driver (not illustrated) of collimation lens 32 that are provided in laser head 30. Controller 50 further controls operation of manipulator 60. The laser welding program is stored in a storage (not illustrated) provided inside controller 50 or at another place, and is invoked in controller 50 by a command from controller 50.

Controller 50 includes an integrated circuit (not illustrated) such as a large-scale integration (LSI) or a microcomputer. When the laser welding program, which is software, is performed on the integrated circuit, the above-described functions of controller 50 are implemented. Controller 50 that controls the operation of laser head 30 and controller 50 that controls the output of laser beam LB may be provided separately.

Manipulator 60 is an articulated robot, and is attached to housing 31 of laser head 30. Manipulator 60 is connected to controller 50 to allow transmission and reception of a signal therebetween, and moves laser head 30 while causing a predetermined trajectory to be drawn in accordance with the laser welding program described above. Another controller (not illustrated) may be provided for controlling the operation of manipulator 60.

[Drawing Speed of Lissajous Pattern]

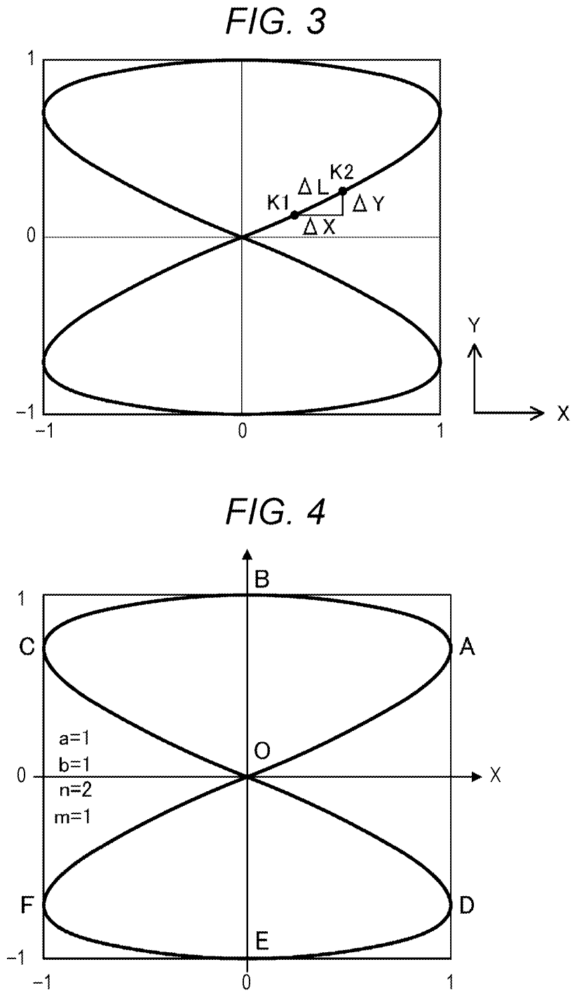

FIG. 3 is a schematic diagram illustrating a drawing distance in a Lissajous pattern. As illustrated in FIG. 3, laser beam LB is swept to draw a Lissajous pattern (hereinafter, it is also referred to as a Lissajous figure) in the XY plane, in this case, on the surface of workpiece 200.

The Lissajous pattern illustrated in FIG. 3 has a width in the X direction that is equal to a width in the Y direction, and the width in the Y direction is substantially equal to width W in the Y direction of a weld bead (not illustrated) when welding speed is very high. In contrast, when the welding speed is low, the width of the weld bead increases under influence of heat conduction. Thus, the width of the Lissajous pattern in the Y direction is slightly narrower than the width of the weld bead in the Y direction. In the specification of the present application, “substantially equal” or “substantially identical” means that control results of respective control targets are identical or identical with an error of a control system, and does not require both the control targets to be strictly equal or identical. Additionally, “substantially equal” or “substantially identical” is also used as a meaning of equality or identification including manufacturing tolerances and assembly tolerances of each component and the like.

The Lissajous pattern illustrated in FIG. 3 is obtained by vibrating laser beam LB at a predetermined frequency in the X direction in a sinusoidal wave shape and vibrating laser beam LB at a frequency different from that in the X direction (½ of the frequency in the X direction) in the Y direction in a sinusoidal wave shape. As described above, scanning figures in the X direction and the Y direction of laser beam LB are determined based on rotational movements of first mirror 41a and second mirror 42a. When the Lissajous pattern illustrated in FIG. 3 and obtained by driving first mirror 41a has a position coordinate designated as X1, and the Lissajous pattern illustrated in FIG. 3 and obtained by driving second mirror 42a has a position coordinate designated as Y1, position coordinates X1, Y1 are generally expressed by Expressions (1) and (2) below, respectively.

X1=a×sin(nt) (1)

Y1=b×sin(mt+φ) (2)

where a is an amplitude of Lissajous pattern illustrated in FIG. 3 in the X direction, b is an amplitude of the Lissajous pattern illustrated in FIG. 3 in the Y direction, n is a frequency of first mirror 41a, m is a frequency of second mirror 42a, t is time, and y is a phase difference when first mirror 41a or second mirror 42a is driven, specifically, an angle difference provided between first mirror 41a and second mirror 42a at the time of rotational movement.

Position coordinates X1, Y1 indicated in Expressions (1), (2) are expressed by a stationary coordinate system of a Lissajous waveform in a state where laser head 30 is fixed at a position.

Frequency n and frequency m correspond to driving frequencies of first mirror 41a and second mirror 42a, respectively.

The Lissajous pattern illustrated in FIG. 3 is an 8-shaped Lissajous pattern corresponding to a case where a=1, b=1, n=2, m=1, and φ=0 in Expressions (1), (2). Amplitudes a and b are normalized by 1. Phase difference φ in Expressions (1), (2) may be any one of 0 degrees and 180 degrees.

Here, when a drawing distance of the Lissajous pattern in the X direction at a predetermined time variation Δt is denoted by ΔX, a drawing distance of the Lissajous pattern in the Y direction is denoted by ΔY, and a drawing distance of the Lissajous pattern at the time variation Δt is denoted by ΔL, as illustrated in FIG. 3, ΔX, ΔY, ΔL are expressed by Expressions (3) to (5), respectively.

ΔX=a×n×cos(nt)×Δt (3)

ΔY=b×m×cos(mt+φ)×Δt (4)

ΔL=Δt×{(ΔX)²+(ΔY)²}^{1/2} (5)

Thus, drawing speed V of the Lissajous pattern is expressed by Expression (6) below.

V=ΔL/Δt (6)

### [Laser Welding Method]

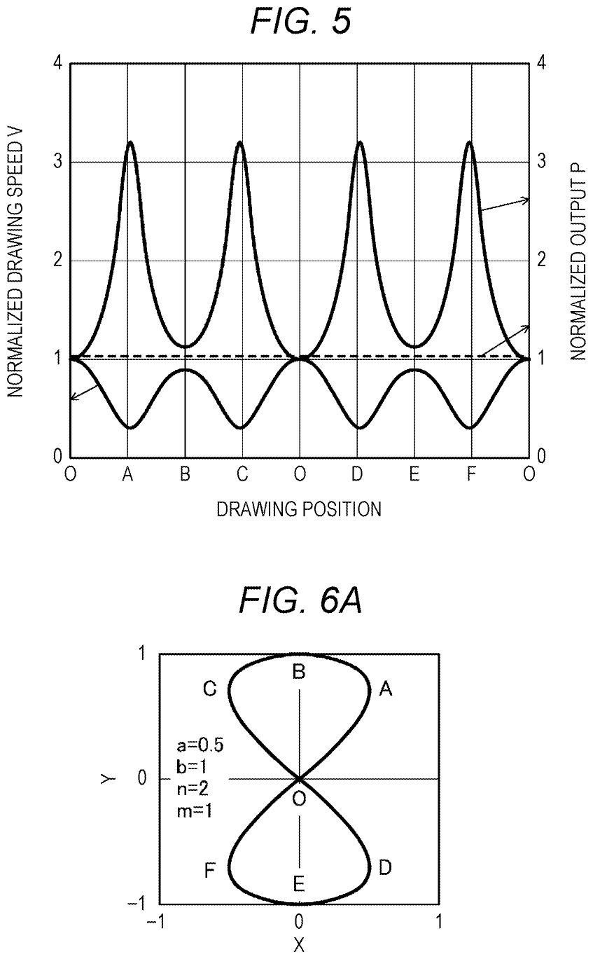

FIG. 4 illustrates a scanning pattern of a laser beam according to the present exemplary embodiment, and FIG. 5 illustrates a relationship between a drawing speed and an output of the laser beam at a drawing position of the laser beam. The scanning pattern illustrated in FIG. 4 is identical in shape to the Lissajous pattern illustrated in FIG. 3. That is, the scanning pattern illustrated in FIG. 4 is an 8-shaped Lissajous pattern corresponding to a case where a=1, b=1, n=2, m=1, and φ=0 in Expressions (1), (2) described above. The Lissajous pattern has an actual size, or an amplitude in each of the X direction and the Y direction, being about 1 mm to 10 mm that however may vary depending on the workpiece to be welded.

FIG. 5 illustrates drawing speed V of laser beam LB that has a value calculated based on Expression (6) described above. Drawing speed V is normalized with drawing speed of laser beam LB when passing through original point O as 1. Similarly, output P of laser beam LB is normalized with output of laser beam LB when passing through original point O as 1.

The present exemplary embodiment allows the surface of workpiece 200 to be irradiated with laser beam LB while laser head 30 is moved at a predetermined speed in the X direction by manipulator 60. There is described an example in which workpiece 200 is welded by laser welding by further sweeping laser beam LB two-dimensionally using laser scanner 40 to draw the Lissajous pattern illustrated in FIG. 4 on the surface of workpiece 200. The pattern illustrated in FIG. 4 is obtained by sweeping laser beam LB from original point O to pass through drawing positions A, B, C, O, D, E, F, and O in this order during one cycle.

When output of laser beam LB is denoted by P in the present exemplary embodiment, output P and drawing speed V of laser beam LB are controlled to allow a relationship between output P and drawing speed V when the Lissajous pattern illustrated in FIG. 4 is drawn by laser beam LB to satisfy a relationship represented by Expression (7) below.

PV=const (7)

where const. is a constant, and is a value corresponding to a shape of a weld of workpiece 200, which is an object to be welded, a penetration shape in the weld, or the like.

When the Lissajous pattern illustrated in FIG. 4 is drawn on the surface of workpiece 200 by sweeping laser beam LB, drawing speed V usually decreases in a region where the Lissajous pattern is changed in direction, or in a region near each of drawing positions A, C, D, F, as illustrated in FIG. 5.

Then, when laser beam LB has output P with an equal value at each drawing position as indicated by a broken line in FIG. 5, the amount of heat input per unit drawing length of the Lissajous pattern illustrated in FIG. 4 differs at each drawing position. For example, the amount of heat input per unit drawing length in a region near drawing position B is smaller than the amount of heat input per unit drawing length in a region near original point O.

In this case, a weld bead may not be formed in a favorable shape because the amount of heat input to each irradiated region of laser beam LB during welding is non-uniform as described above to hinder a key hole from having a stable depth to keep a penetration depth constant. This case also may cause a narrow appropriate condition range of drawing speed V and output P of laser beam LB in laser welding.

Thus, the present exemplary embodiment allows laser beam LB to be controlled to have drawing speed V and output P satisfying the relationship shown in Expression (7) above. In other words, drawing speed V and output P of a laser beam are controlled to have an equal amount of heat input per unit drawing length in the Lissajous pattern over the entire length of the Lissajous pattern.

Specifically, laser beam LB is controlled to have output P increasing as laser beam LB approaches each of drawing positions A, C, D, F where drawing speed V decreases, as indicated by a solid line in FIG. 5. Laser beam LB is also controlled to have output P decreasing as laser beam LB separates from each of drawing positions A, C, D, F.

Laser beam LB is also controlled to have output P decreasing as laser beam LB approaches each of drawing positions O, B, E where drawing speed V increases. Laser beam LB is also controlled to have output P increasing as laser beam LB separates from each of drawing positions O, B, E. Both drawing speed V and output P continuously change with respect to each drawing position.

[Effects and the Like]

As described above, the laser welding method according to the present exemplary embodiment includes the welding step of welding workpiece 200 by irradiating the surface of workpiece 200 with laser beam LB that is swept two-dimensionally while being advanced in the X direction (first direction).

The welding step is configured to vibrate laser beam LB not only at a first frequency corresponding to frequency n along the X direction in a sinusoidal wave shape, but also at a second frequency corresponding to frequency m along the Y direction in a sinusoidal wave shape. As a result, laser beam LB is swept to draw the Lissajous pattern on the surface of workpiece 200.

Additionally, drawing speed V and output P of laser beam LB are controlled to have an equal amount of heat input per unit drawing length in the Lissajous pattern over the entire length of the Lissajous pattern.

The laser welding method of the present exemplary embodiment enables an equal amount of heat input per unit drawing length in the Lissajous pattern to be supplied over the entire length of the Lissajous pattern, so that a penetration depth in a weld can be kept constant by stabilizing a depth of a key hole (not illustrated) in the weld. Additionally, a weld bead can be formed in a favorable shape. Then, a process margin of laser welding can be secured without narrowing an appropriate condition range of drawing speed V and output P of laser beam LB.

Laser welding device 100 according to the present exemplary embodiment at least includes laser oscillator 10 that generates laser beam LB, laser head 30 that receives laser beam LB and that applies laser beam LB to workpiece 200, and controller 50 that controls operation of laser head 30.

Laser head 30 includes laser scanner 40 that sweeps laser beam LB in each of the X-direction (the first direction) and the Y-direction (the second direction) intersecting the X-direction.

Controller 50 vibrates laser beam LB not only at the first frequency along the X direction in a sinusoidal wave shape, but also at the second frequency along the Y direction in a sinusoidal wave shape. As a result, controller 50 drives and controls laser scanner 40 to cause laser beam LB to draw a Lissajous pattern on the surface of workpiece 200.

Additionally, controller 50 controls drawing speed V and output P of laser beam LB to have an equal amount of heat input per unit drawing length in the Lissajous pattern over the entire length of the Lissajous pattern.

Laser welding device 100 of the present exemplary embodiment enables a penetration depth to be kept constant by stabilizing a depth of a key hole. Additionally, a weld bead can be formed in a favorable shape. Then, a process margin of laser welding can be secured without narrowing an appropriate condition range of drawing speed V and output P of laser beam LB.

Laser welding device 100 further includes manipulator 60 to which laser head 30 is attached, and controller 50 controls the operation of manipulator 60. Manipulator 60 causes laser head 30 to move in a predetermined direction with respect to the surface of workpiece 200.

Providing manipulator 60 in this manner enables changing a welding direction of laser beam LB. Additionally, laser welding can be easily performed on workpiece 200 having a complex shape such as a three-dimensional shape.

Laser oscillator 10 and laser head 30 are connected by optical fiber 20, and laser beam LB is transmitted from laser oscillator 10 to laser head 30 through optical fiber 20.

Providing optical fiber 20 in this manner enables performing laser welding on workpiece 200 disposed at a position away from laser oscillator 10. As a result, a degree of freedom in placement of each component of laser welding device 100 can be enhanced.

Laser scanner 40 includes first galvano-mirror 41 that sweeps laser beam LB in the X-direction, and second galvano-mirror 42 that sweeps laser beam LB in the Y-direction.

Laser scanner 40 configured as described above enables sweeping laser beam LB two-dimensionally. The known galvano-scanner is used for laser scanner 40, and thus increase in cost of laser welding device 100 can be suppressed.

Laser head 30 further includes collimation lens 32, and collimation lens 32 is configured to change a focal position of laser beam LB along the Z direction intersecting each of the X direction and the Y direction. That is, collimation lens 32 in combination with the driver (not illustrated) also functions as a focal position adjustment mechanism for laser beam LB.

This configuration enables the focal position of laser beam LB to be easily changed, so that laser beam LB can be appropriately emitted in accordance with a shape of workpiece 200.

Although in the present exemplary embodiment, laser head 30 is moved in the X direction to advance laser beam LB in the X direction, the present invention is not particularly limited thereto. Laser head 30 may be moved in the Y direction to advance laser beam LB in the Y direction.

Additionally, a drawing direction of the Lissajous pattern is also not particularly limited to the description above. For example, the Lissajous pattern may be drawn by sweeping laser beam LB from original point O to pass through drawing positions C, B, A, O, F, E, D, and O in this order during one cycle. Alternatively, the Lissajous pattern may be drawn by sweeping laser beam LB from original point O to pass through drawing positions D, E, F, O, A, B, C, and O in this order during one cycle. Additionally, the Lissajous pattern may be drawn by sweeping laser beam LB from original point O to pass through drawing positions F, E, D, O, C, B, A, and O in this order during one cycle.

<First Modification>

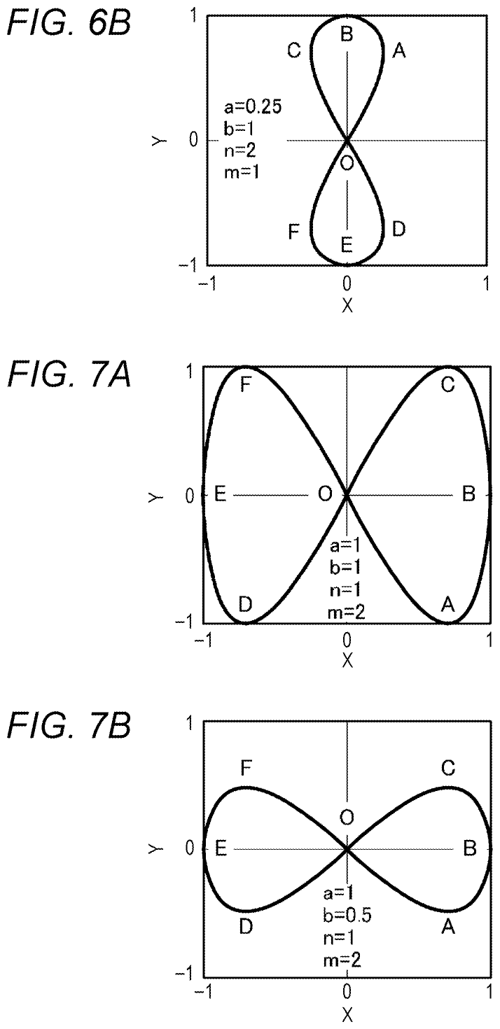

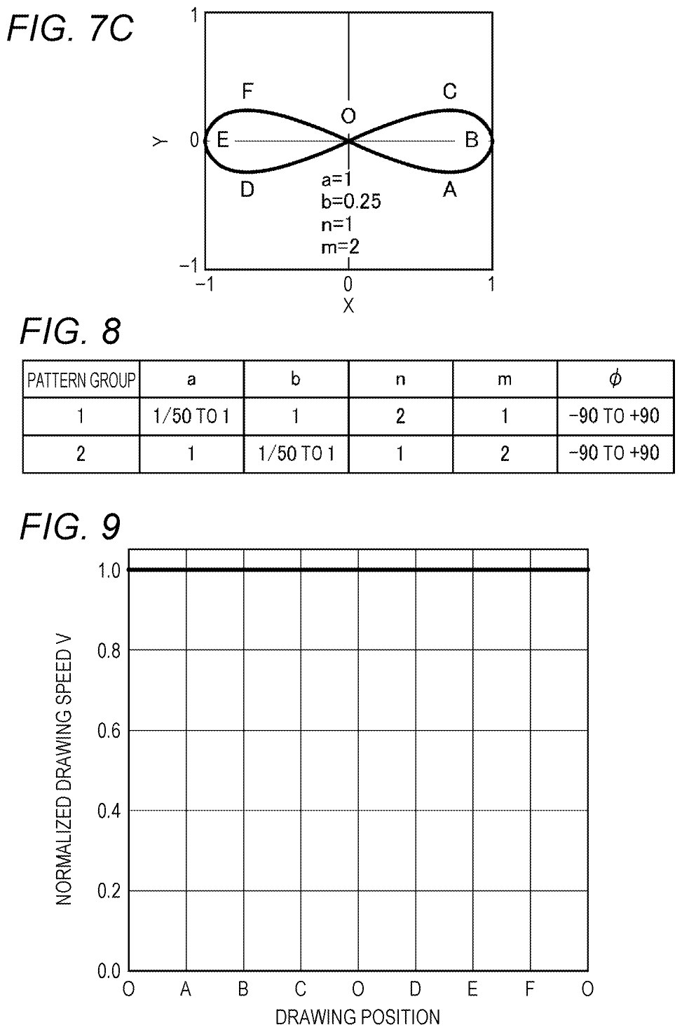

FIG. 6A illustrates a first scanning pattern of a laser beam according to the present modification, and FIG. 6B illustrates a second scanning pattern. FIG. 7A illustrates a third scanning pattern of a laser beam according to the present modification, FIG. 7B illustrates a fourth scanning pattern, and FIG. 7B illustrates a fifth scanning pattern. FIG. 8 illustrates an example of a combination of parameters when a Lissajous pattern is drawn. FIG. 6A and sequent drawings denote the same parts as those of the first exemplary embodiment with the same reference numerals, and details thereof will not be described.

Parameters a, b, n, and m shown in Expressions (1) and (2) in actual laser welding can be appropriately changed depending on a material, a joint shape, a required bead shape width, and the like of workpiece 200. Thus, the scanning pattern of laser beam LB is not particularly limited to the pattern illustrated in FIG. 4.

For example, parameter a may be decreased to decrease an amplitude of the Lissajous pattern in the X direction, as illustrated in FIGS. 6A, 6B. Frequency n may be set to 1 and frequency m may be set to 2 to form a scanning pattern obtained by rotating the Lissajous pattern illustrated in FIG. 4 by 90 degrees as illustrated in FIG. 7A. Parameter b may be decreased to decrease an amplitude in the Y direction of the Lissajous pattern illustrated in FIG. 7A, as illustrated in FIGS. 7B, 7C.

Parameters a, b illustrated in Expressions (1), (2), respectively, have values that are not particularly limited to the examples illustrated in FIGS. 6A, 6B and FIGS. 7A to 7C, and that can be appropriate values within a range illustrated in FIG. 8, for example. FIG. 8 shows a pattern group 1 that is the Lissajous patterns illustrated in FIG. 4 and FIGS. 6A, 6B, and a pattern group 2 that the Lissajous patterns illustrated in FIGS. 7A to 7C.

When a ratio of frequency n of first mirror 41a to frequency m of second mirror 42a, i.e., a ratio of the first frequency being a vibration frequency in the X direction of laser beam LB to the second frequency being a vibration frequency in the Y direction, is set to 2:1 or 1:2, an 8-shaped Lissajous pattern can be obtained. First mirror 41a and second mirror 42a each have a drive frequency that may be changed depending on a shape of workpiece 200 or a required bead shape as long as the ratio of frequencies is maintained.

### Second Exemplary Embodiment

FIG. 9 illustrates a relationship between a drawing position of a laser beam and drawing speed of the laser beam.

As is evident from FIG. 9, laser beam LB is controlled in the present exemplary embodiment to have constant drawing speed regardless of a drawing position of laser beam LB. That is, the laser welding method according to the present exemplary embodiment includes the welding step in which drawing speed V of laser beam LB is controlled to be constant over the entire length of the Lissajous pattern. Laser welding device 100 according to the present exemplary embodiment includes controller 50 that controls drawing speed of laser beam LB to be constant over the entire length of the Lissajous pattern.

As with the first exemplary embodiment, the present exemplary embodiment allows output P and drawing speed V of laser beam LB to be controlled to satisfy the relationship shown in Expression (7). Thus, the present exemplary embodiment allows drawing speed V and output P of laser beam LB to be each controlled to be constant over the entire length of the Lissajous pattern. However, drawing speed V in this case does not satisfy the relationships shown in Expressions (3) to (6).

This control described above enables achieving effects similar to those achieved by the configuration shown in the first exemplary embodiment. That is, the amount of heat input per unit drawing length in the Lissajous pattern can be made equal over the entire length of the Lissajous pattern, so that a penetration depth can be kept constant by stabilizing a depth of the key hole. Additionally, a weld bead can be formed in a favorable shape. Scanning control of laser beam LB is simplified by making drawing speed V and output P of laser beam LB constant over the entire length of the Lissajous pattern. Control of the amount of heat input to workpiece 200 is also facilitated.

<Second Modification>

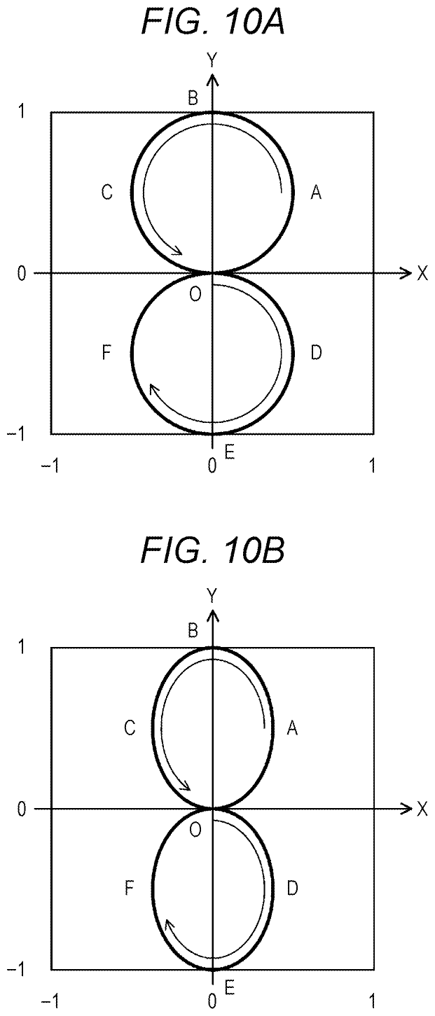

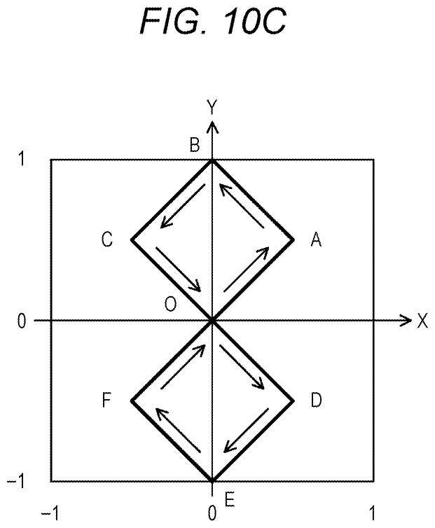

FIGS. 10A to 10C illustrate first to third scanning patterns of a laser beam according to the present modification, respectively. FIGS. 10A to 10C each show arrows that indicate drawing directions of a laser beam LB.

The scanning pattern of laser beam LB of the present disclosure is not limited to the Lissajous pattern described in the first exemplary embodiment or the first modification. For example, the scanning pattern may be a composite pattern of two circular patterns disposed symmetrically with respect to the X axis while being in contact with each other at original point O as illustrated in FIG. 10A. Alternatively, the scanning pattern may be a composite pattern of two elliptical patterns disposed symmetrically with respect to the X axis while being in contact with each other at original point O as illustrated in FIG. 10B. Although FIG. 10B illustrates an example in which each of the two elliptical patterns has a major axis in the Y direction and a minor axis in the X direction, the major axis may be in the X direction and the minor axis may be in the Y direction. As illustrated in FIG. 10C, the scanning pattern may be a composite pattern of two rhombus patterns disposed symmetrically with respect to the X axis while being in contact with each other at original point O. Although not illustrated, each of the scanning patterns illustrated in FIGS. 10A to 10C may be a combined pattern of two annular patterns disposed symmetrically with respect to the Y axis. In this case, each of the two annular patterns may be a pattern rotated by 90 degrees from the examples illustrated in FIGS. 10A to 10C. Each of the two annular patterns can be further appropriately changed in size.

That is, the scanning pattern of laser beam LB in the present specification may be a pattern in which two annular patterns are continuous and in contact with each other at one point, and is not limited to the examples illustrated in FIGS. 10A to 10C and the modifications thereof. These patterns are obtained by driving first mirror 41a and second mirror 42a according to a predetermined drive pattern.

Thus, the laser welding method of the present disclosure includes the welding step in which laser beam LB is swept to draw a predetermined pattern on the surface of workpiece 200.

Additionally, drawing speed V and output P of laser beam LB are controlled to have an equal amount of heat input per unit drawing length in the predetermined pattern over the entire length of the predetermined pattern.

Controller 50 in laser welding device 100 of the present disclosure drives and controls laser scanner 40 such that laser beam LB draws a predetermined pattern on the surface of workpiece 200.

Additionally, controller 50 controls drawing speed V and output P of laser beam LB to have an equal amount of heat input per unit drawing length in the predetermined pattern over the entire length of the predetermined pattern.

The “predetermined pattern” is the scanning pattern of laser beam LB in which two annular patterns are continuous and in contact with each other at one point, in this case, at original point O. More specifically, the two annular patterns are identical to each other. It is needless to say that the “predetermined pattern” includes the Lissajous pattern disclosed in the present specification.

The laser welding method and laser welding device 100 configured as described above enables achieving effects similar to those achieved by the configurations described in the first and second exemplary embodiments and the first modification.

### Other Exemplary Embodiments

Another exemplary embodiment can be formed by appropriately combining components described in the first and second exemplary embodiments and the first and second modifications.

For example, when each scanning pattern illustrated in the first and second modifications is drawn, drawing speed V and output P of laser beam LB can be controlled to be constant over the entire length of the predetermined pattern as shown in the second exemplary embodiment.

In the first and second modifications, and the second exemplary embodiment, a predetermined pattern may be drawn by sweeping laser beam LB from original point O to pass through drawing positions C, B, A, O, F, E, D, and O in this order during one cycle, for example. Alternatively, the predetermined pattern may be drawn by sweeping laser beam LB from original point O to pass through drawing positions D, E, F, O, A, B, C, and O in this order during one cycle. Additionally, the predetermined pattern may be drawn by sweeping laser beam LB from original point O to pass through drawing positions F, E, D, O, C, B, A, and O in this order during one cycle.

Although FIG. 1 illustrates the example in which condenser lens 34 is disposed at a stage prior to laser scanner 40, condenser lens 34 may be disposed at a stage subsequent to laser scanner 40, or a position between laser scanner 40 and a beam emission port of laser head 30.

Laser beam LB may has a scanning pattern of the Lissajous pattern by vibrating laser beam LB not only at a first frequency along the X direction in a cosine wave shape but also at a second frequency along the Y direction in a cosine wave shape. It is needless to say that amplitudes a, b of first mirror 41a and second mirror 42a, frequencies n, m of first mirror 41a and second mirror 42a, and phase φ are appropriately changed in this case.

### INDUSTRIAL APPLICABILITY

The laser welding method and the laser welding method according to the present disclosure are useful because a weld bead can be formed in a favorable shape.

### REFERENCE MARKS IN THE DRAWINGS

10 laser oscillator
20 optical fiber
30 laser head
31 housing
32 collimation lens
33 reflection mirror
34 condenser lens
40 laser scanner
41 first galvano-mirror
41a first mirror
41b first rotation shaft
41c first driver
42 second galvano-mirror
42a second mirror
42b second rotation shaft
42c second driver
50 controller
60 manipulator
200 workpiece

1. A laser welding method comprising a welding step of welding a workpiece by irradiating a surface of the workpiece with a laser beam by two-dimensionally sweeping the laser beam while causing the laser beam to travel in a first direction, wherein
the welding step includes
sweeping the laser beam to draw a predetermined pattern on the surface of the workpiece, and
controlling drawing speed and output of the laser beam to have an equal amount of heat input per unit drawing length in the predetermined pattern over an entire length of the predetermined pattern, and
the predetermined pattern is a continuous pattern in which two annular patterns are in contact with each other at one point.

2. The laser welding method according to claim 1, wherein
the predetermined pattern is a Lissajous pattern in an 8-shape or 8-shape turned sideways, and
the welding step includes sweeping the laser beam to draw the Lissajous pattern on the surface of the workpiece by vibrating the laser beam not only at a first frequency in the first direction in a sinusoidal wave shape but also at a second frequency in a second direction intersecting the first direction in a sinusoidal wave shape.

3. The laser welding method according to claim 2, wherein a ratio of the first frequency to the second frequency is 2:1 or 1:2.

4. The laser welding method according to claim 1, wherein the drawing speed of the laser beam is controlled to be constant over an entire length of the predetermined pattern.

5. A laser welding device at least comprising:
a laser oscillator that generates a laser beam;
a laser head that receives the laser beam and irradiates a workpiece with the laser beam; and
a controller that controls operation of the laser head, wherein
the laser head includes a laser scanner that sweeps the laser beam in each of a first direction and a second direction intersecting the first direction,
the controller is configured to drive and control the laser scanner to cause the laser beam to draw a predetermined pattern on a surface of the workpiece,
the controller is also configured to control drawing speed and output of the laser beam to have an equal amount of heat input per unit drawing length in the predetermined pattern over an entire length of the predetermined pattern, and
the predetermined pattern is a continuous pattern in which two annular patterns are in contact with each other at one point.

6. The laser welding device according to claim 5, wherein
the predetermined pattern is a Lissajous pattern in an 8-shape or 8-shape turned sideways, and
the controller drives and controls the laser scanner to allow the laser beam to draw the Lissajous pattern on the surface of the workpiece by vibrating the laser beam not only at a first frequency in the first direction in a sinusoidal wave shape but also at a second frequency in the second direction in a sinusoidal wave shape.

7. The laser welding device according to claim 6, wherein a ratio of the first frequency to the second frequency is 2:1 or 1:2.

8. The laser welding device according to claim 5, wherein the controller controls the drawing speed of the laser beam to cause the drawing speed of the laser beam to be constant over an entire length of the predetermined pattern.

9. The laser welding device according to claim 5, further comprising a manipulator to which the laser head is attached, wherein
the controller controls an operation of the manipulator, and
the manipulator moves the laser head in a predetermined direction against the surface of the workpiece.

10. The laser welding device according to claim 5, wherein
the laser oscillator and the laser head are connected by an optical fiber, and
the laser beam is transmitted from the laser oscillator to the laser head through the optical fiber.

11. The laser welding device according to claim 5, wherein the laser scanner includes a first galvano-mirror configured to sweep the laser beam in the first direction, and a second galvano-mirror configured to sweep the laser beam in the second direction intersecting the first direction.

12. The laser welding device according to claim 5, wherein
the laser head further includes a focal position adjustment mechanism, and
the focal position adjustment mechanism is configured to cause a focal position of the laser beam to change along a direction intersecting each of the first direction and the second direction.
